(19) United States
(12) Patent Application Publication
(10) Pub. No.: US 2025/0143234 A1
(43) Pub. Date: May 8, 2025

(54) PORTABLE ELECTRIC TYING MACHINE FOR BINDING PLANTS

(71) Applicant: INNOVATION FABRICATION COMMERCIALISATION INFACO, Cahuzac-sur-Vère (FR)

(72) Inventors: Christophe GOUT, Castelnau-de-Lévis (FR); Guillaume CLOT, Lisle-sur-Tarn (FR)

(21) Appl. No.: 18/832,212

(22) PCT Filed: Jan. 16, 2023
(86) PCT No.: PCT/EP2023/050905

§ 371 Date: Jul. 23, 2024

(30) Foreign Application Priority Data
Jan. 25, 2022 (FR) FR2200630

(51) Int. Cl. A01G 17/08; B65B 13/06; B65B 13/08; B65B 13/28

(52) U.S. Cl. CPC A01G 17/085; B65B 13/06; B65B 13/08; B65B 13/285

(57) ABSTRACT

A portable electric tying machine for binding plants, including a body, a motor, an immobile tying head and a guide path for a tying wire, a system for driving the tying wire into the guide path, and a mechanism for twisting the tying wire. The drive system includes a first mechanism for pushing the tying wire to an intermediate position, situated in the tying head, and a second movable mechanism for pulling the tying wire from the intermediate position, to reach a twisting position, and wherein the second mechanism includes a movable arm equipped with a means for gripping the tying wire, the movable arm being configured for positioning the gripping means in the intermediate position such that the gripping means can grip the tying wire in the intermediate position, and retracted to the twisting position such that the gripping means can release the tying wire in the twisting position.

The present invention concerns an portable electric tying machine for binding plants, in particular vines.

The field of the invention is that of portable electric tying machines for binding plants, in particular vines.

### PRIOR ART

Many portable electric tying machines are known for binding plants, in particular vines. Generally speaking, tying machines comprise a tying head, a mechanism for twisting a wire onto a branch to be tied and a system for driving said wire into the tying head and into a position to be twisted.

However, today's portable electric tying machines for binding plants are not without limitations. For instance, current tying machines have reliability problems. It is common, for example, for the tying wire to jam in the body of the tying machine. The tying machine therefore requires regular maintenance and repair.

In addition, tying machines of the prior art also tend to perform certain ties incorrectly, as the tying wire has not been positioned correctly before being twisted. As a result, the user may have to repeat the process several times over. All these drawbacks slow down the pace at which the user can work, which in turn reduces the number of ties that person can perform in a working day.

One aim of the present invention is to solve at least one of the above-mentioned shortcomings.

Another aim of the present invention is to provide a more reliable tying machine with a faster work pace.

### DISCLOSURE OF THE INVENTION

The invention makes it possible to achieve at least one of these aims through a portable electric tying machine for binding plants, in particular for binding vines, comprising:
a body,
at least one motor in said body,
a tying head, disposed at a distal end of said body, said tying head comprising a guide path for a tying wire,
a system for driving said tying wire in said guideway, and
a mechanism for twisting said tying wire;
   wherein:
said tying head is immobile,
said drive system comprises:
   a first mechanism for pushing the tying wire to an intermediate position situated in said tying head, and
   a second movable mechanism for pulling said tying wire from said intermediate position into a position referred to as twisting position.

The invention thus offers a tying machine comprising two separate mechanisms for driving a tying wire. The first mechanism pushes the tying wire into the tying head and the second mechanism picks up one end of said wire from the tying head and pulls it into a position where it will be twisted.

Thus, to create a tie, the first mechanism can be used solely to push the tying wire into said tying head and need not be used to position the tying wire in the twisting position.

Unlike conventional tying machines, which use the same mechanism to first push the tying wire into the tying head, and then, in a second step, to push the wire into a twisting position during a brief activation requiring a high drive speed, the first mechanism of the tying machine according to the invention is used to position the wire in an intermediate position, but does not need to be used to position the wire in the twisting position. Wire positioning in an intermediate position, known as the pre-loading phase, can thus be carried out between two ties, at a moderate drive speed.

As a result, the tying machine according to the invention makes it easier to control the driving of the tying wire. This makes the wire less likely to slip or jam in the drive mechanism. As a result, the tying machine according to the invention is more reliable than prior art solutions.

Above all, the tying machine according to the invention features an immobile tying head, which makes the tying machine more robust and less maintenance-intensive. This is because the tying head comes into contact with plants, such as vines, during tying operations, which constitutes a high risk of damage to a mobile tying head, and its mechanism, in known tying machines.

In addition, the tying machine according to the invention offers a second mechanism, distinct from the first mechanism, for fetching one end of said wire from the tying head and then pulling it to a position for twisting.

In this way, the invention enables the tying wire to be positioned in the twisting position more reliably than prior art solutions which push the tying wire into the twisting position. As a result, the tying machine makes tying more reliable.

As a result, the tying machine enables a higher work pace, as it is less likely that a user will have to perform a tying operation twice to get it right.

Advantageously, the tying head can be beak-shaped, comprising a housing designed to position therein a branch of a plant, in particular a vine branch, to be tied.

This makes it easy to position the tying machine on a branch to form a tie.

In fact, a branch to be tied can be positioned in the housing of said beak of the immobile tying head so that the second mobile mechanism can fetch a tying wire present in the tying head at the intermediate position and bring it into a twisting position without the second mechanism being hindered by said branch to be tied.

In addition, the use of a beak-shaped tying head provides a guide path for a tying wire of greater length, thus reducing the distance between the intermediate position and the so-called twisting position. As a result, the distance the second moving mechanism has to travel to pick up an end of said wire at the tying head and then pull it to the position to be twisted is reduced. Thus, the time required for the second mechanism to fetch one end of said wire from the tying head and then pull it to the position to be twisted is also reduced.

Advantageously, the first mechanism may comprise:
a first, motorized roller, called the drive roller,
a second roller, called the pressing roller, designed to press said tying wire against the drive roller,
   so that said rollers drive the tying wire when they are in motion.

As a non-limiting example, a motorized roller can be a roller driven by a motor of said tying machine.

As a non-limiting example, a pressing roller can be mounted on a mobile support, such as a lever, in contact with a spring bearing on an element of the tying machine body so that it applies a force to the mobile support and enables said pressing roller to press the tying wire against said drive roller.

A non-limiting example of a mobile support may be a lever, preferably non-removable, designed to pivot sufficiently, for example more than 90°, to enable a user to access the drive roller during a maintenance operation on the tying machine.

Using a pressing roller allows for accommodating a variation in the distance between a center of rotation of the drive roller and a center of rotation of the pressing roller, making it possible to drive tying wires of different thicknesses or to drive a wire of varying thickness, for example when twisted.

In one embodiment, the pressing roller can be rotated by the drive roller via friction.

Preferentially, the first mechanism may comprise:
a first toothed wheel integral with said drive roller, and
a second toothed wheel integral with the pressing roller, meshing with said first toothed wheel.

In this way, it is possible to synchronize the rotation of the drive roller and the pressing roller, resulting in improved driving of the tying wire by the first mechanism. Synchronized rotation of the motor roller and pressing roller reduces the risk of the tying wire slipping when driven.

Advantageously, said first and second toothed wheels can have a tooth profile designed to accommodate a variation in the distance between a center of rotation of said drive roller and a center of rotation of said pressing roller.

As a non-limiting example, in comparison with a standard tooth profile allowing optimized transmission of motion between the two toothed wheels, the tooth profile of the first toothed wheel and/or the second toothed wheel may have:
increased tooth height,
reduced tooth thickness, and/or
increased tooth spacing.

In this way, the drive roller is able to drive the pressing roller synchronously even when the distance between a center of rotation of the drive roller and a center of rotation of the pressing roller varies, notably to accommodate the passing of a twist in the driven wire.

Advantageously, the second mechanism may comprise a movable arm equipped with a means for gripping said tying wire, said movable arm being able to be:
extended to position said gripping means at said intermediate position, so that the gripping means can grip the tying wire in the intermediate position, and
retracted to position said gripping means at said twisting position, so that the gripping means can release the tying wire at the twisting position.

Thus, once the wire has been gripped, the tying wire is held by said gripping means and pulled from the intermediate position to the twisting position.

As a result, the tying machine according to the invention enables the tying wire to be brought more reliably into the twisting position.

Preferably, when the movable arm is retracted, the second mechanism is located outside the twisting mechanism's field of action. Preferentially, when the movable arm is retracted, the second mechanism in the tying machine body, and in front of the twisting mechanism in a longitudinal direction of the tying machine, from the user's point of view.

According to one embodiment, the gripping means can be a hook, a suction cup, a gripping surface such as Velcro, etc.

Advantageously, the gripping means can be a clamp.

In this way, the gripping means is easy to operate and enables reliable and repeatable gripping and release of a tying wire.

Advantageously, the second mechanism comprises at least one actuating means to:
trigger the gripping of said tying wire by said gripping means, by abutment of said actuating means with the tying head when the movable arm is extended, and/or
trigger the release of said tying wire by said gripping means, by abutment of said actuating means, when the movable arm is retracted.

In this way, it is possible to mechanically trigger the gripping and/or release of the tying wire by the gripping means. As a result, it is not necessary to equip the tying machine with a motor dedicated to triggering the gripping means.

In addition, the use of an actuating means to mechanically trigger the gripping of the tying wire when the movable arm is extended and the actuating means is brought into abutment enables gripping to be triggered only when the gripping means is positioned in the intermediate position.

Furthermore, the use of an actuating means to mechanically trigger the release of the tying wire when the movable arm is retracted and the actuating means is brought into abutment enables the release to be triggered only when the gripping means is positioned in the twisting position.

As a result, the gripping means of the second mechanism is able to grip and/or release the wire more reliably, and thus position the tying wire at the twisting position more reliably.

By way of example, a single actuating means can be used to trigger the gripping and release of the tying wire.

In addition, at least one actuating means can be integrated into the gripping means.

Again by way of example, an actuating means can trigger a release of the tying wire by bringing it into abutment with an element of the tying machine body or, more specifically, an element of the second mechanism.

According to one embodiment, the second mechanism may comprise at least one mechanical means for holding the at least one actuating means in position.

Advantageously, the second mechanism may comprise at least one magnetic means for holding the at least one actuating means in position.

In this way, the at least one actuating means can be held in position and prevented from moving accidentally. As a result, the gripping means can be kept in the gripping or release state. In this way, when the gripping means is a clamp, the clamp can be kept closed or open, respectively.

This is particularly advantageous when a wire is gripped from the intermediate position and then pulled into the twisting position. In fact, to guarantee good tying, it is important that the gripping means doesn't accidentally release the wire before it is in the twisting position.

The use of a magnetic holding means enables the actuating means to be held in position until an abutment causes a change in position of said actuating means. This abutment can, for example, move the actuating means away from the magnetic holding means, thus taking it out of the magnetic field of the holding means.

Moreover, unlike mechanical means, the use of a magnetic holding means enables a holding function to be performed with a simple, low-wear architecture.

According to another embodiment, the movable arm can be a lever that can be rotated around a pivot.

Advantageously, the movable arm can be translationally movable.

As a result, the movable arm has a low-complexity architecture, which is easy to integrate into the architecture of a tying machine and easy to drive in motion. The movable arm can, for example, be integrated so that it is fully contained within the body of the tying machine when retracted.

Advantageously, the tying machine may comprise a first motor for driving the first mechanism and the mechanism for twisting said tying wire.

Advantageously, the tying machine may comprise:
a first freewheel system enabling said first mechanism to be driven by said first motor only in a first direction of rotation of a drive shaft of said first motor, and
a second freewheel system enabling said twisting mechanism to be driven by said first motor only in a second direction of rotation of said motor shaft, opposite to said first direction of rotation.

So, although the same first motor drives the first mechanism and the twisting mechanism, it is possible to dissociate the drive for the wire in the tying head from the drive for the twisting means. It is therefore possible to feed wire into the tying head without having to form a tie.

For example, if the wire could not be positioned in the intermediate position because it was blocked upstream of the tying machine, the wire can be driven back into the tying head once the blockage has been removed.

This also enables the wire to be driven to the intermediate position when the tying machine is reloaded with tying wire, thus preparing the tying machine for future tying.

What's more, it's also possible to twist the wire without having to feed it into the tying head.

Advantageously, the tying machine may comprise a second motor, different from the first motor, to drive the second mechanism.

In this way, it is possible for the second mechanism to be driven independently of the drive for the first mechanism and the drive for the twisting mechanism.

The use of a second motor also makes it possible to dissociate the drive of the second mechanism from the other mechanisms, without overcomplicating the internal architecture of the tying machine.

What's more, having a second motor means you can drive the first mechanism and the second mechanism at the same time if required.

In this way, the tying machine can be configured to tie more or less loosely, without altering the number of rotations performed by the twisting mechanism during a tying operation.

In fact, to achieve a looser fastening, it is possible to configure the tying machine so that the first mechanism feeds the wire into the tying head to provide slack after said wire has been gripped by the gripping means.

Alternatively or additionally, to achieve looser tying, the tying machine can be configured so that the first mechanism feeds the wire into the tying head to provide slack after said wire has been positioned in the twisting position.

It is also possible to avoid wasting tying wire when the tying machine is activated but tying cannot be carried out, for example when an obstacle is present between the twisting position and the intermediate position and the second mechanism is unable to fetch the tying wire from the intermediate position. In fact, as the drive of the second mechanism is independent of that of the first mechanism, it is possible, once the tying wire is in the intermediate position, to no longer drive the wire in the tying head until the wire has been positioned in the twisting position.

In alternative embodiments, the second motor can be replaced by any drive means capable of driving the second mechanism, such as a cylinder system.

Advantageously, the tying machine may comprise a cutting tool for cutting the tying wire, wherein the cutting tool is triggerable by the twisting mechanism.

In this way, it is possible to cut the tying wire only when the twisting mechanism is driven.

The cutting tool can, for example, be connected to a drive means of the twisting mechanism so that it too is driven and performs a cut when the twisting mechanism is driven.

In addition, having a tying wire cutting tool that can be triggered by the twisting mechanism is particularly advantageous when the tying machine comprises said first and second freewheel systems described above. This makes it possible to feed wire into the tying head without having to twist the tying wire or cut it.

In addition, having a tying wire cutting tool that can be triggered by the twisting mechanism is also particularly advantageous when the tying machine comprises a second motor, different from the first motor, to drive the second mechanism. In fact, as the drive of the second mechanism is dissociated from the drive of the first drive mechanism and of the twisting mechanism, it is possible to fetch the tying wire at the tying head and pull it to a position for twisting without having to twist the tying wire directly and therefore without having to cut it directly. This is particularly advantageous for allowing the first mechanism of the tying machine to give slack, and thus obtain a looser tie, even after said wire has been positioned in the twisting position by the second mechanism.

Alternatively, the cutting tool can be driven by any other drive means, such as an electromagnet, and the cutting can then be triggered by activation of the twisting means.

In an alternative embodiment, the cutting tool of the tying machine can be triggered by the second mechanism. For example, the cutting tool can be driven by the second mechanism to make the cut when the wire is positioned in the twisting position. According to another example, the cutting tool can be driven by any other drive means, such as an electromagnet, and cutting can then be triggered when the wire is positioned in the twisting position by the second mechanism.

Advantageously, the body may comprise at least one hatch providing access to at least the first mechanism.

In this way, when the user is in the field, they can easily access the first mechanism to check that the tying wire is correctly positioned in the first mechanism after a tying wire refill or to perform a maintenance operation such as unblocking a tying wire jammed in the first mechanism.

What's more, the hatch can be non-removable, so that there is no risk of losing it when the user has to open it in the field.

According to one embodiment, the hatch can provide access to a cutting tool of the tying machine. This makes it easy to change the cutting tool in the field if it becomes worn.

Alternatively or additionally, the body may comprise at least one non-removable hatch allowing access to at least the twisting mechanism and/or the second mechanism.

Advantageously, the tying machine can be equipped with a tying wire reel.

The wire reel can be positioned on the user, for example attached to a user's belt.

Alternatively, the wire reel can be positioned on the tying machine body, either removably or not.

### DESCRIPTION OF THE FIGURES AND EMBODIMENTS

Other benefits and features shall become evident upon examining the detailed description of an entirely non-limiting embodiment, and from the enclosed drawings in which:

FIGS. 1a-1d are partial schematic representations of a non-limiting exemplary embodiment of a tying machine according to the invention;

FIGS. 2a and 2b are schematic, partial cross-sectional views of a non-limiting example of a second movable mechanism for pulling a tying wire according to the invention;

FIG. 3 is a schematic, partial, perspective representation of a non-limiting example of a first mechanism for pushing the tying wire according to the invention;

FIG. 4 is a schematic perspective representation of a tying machine comprising a hatch according to the invention; and

FIG. 5 is a schematic, partial, perspective representation of an example tying machine according to the invention.

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior state of the art. This selection comprises at least one preferably functional feature which lacks structural details, or only has a portion of the structural details if that portion only is sufficient to confer a technical benefit or to differentiate the invention with respect to the prior state of the art.

In the figures the same reference has been used for the elements that are common to several figures.

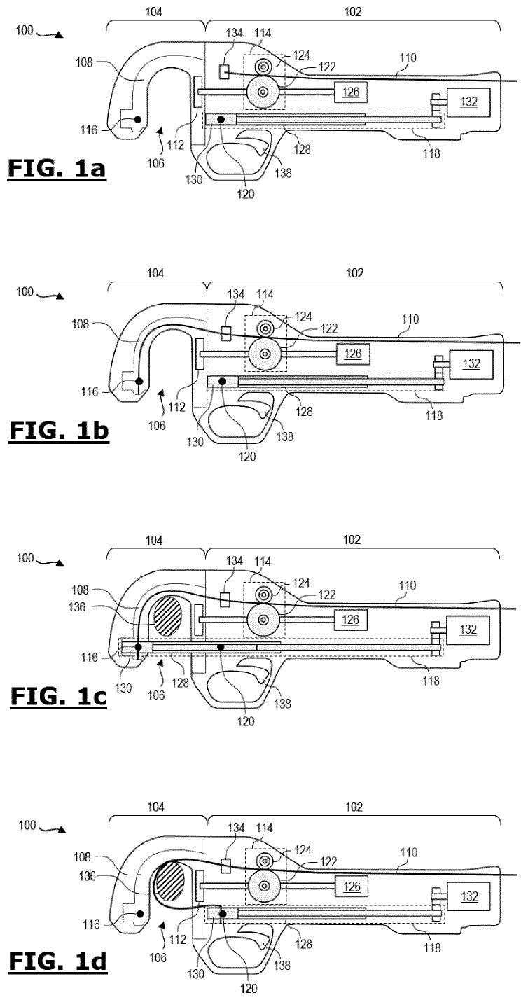

FIGS. 1a-1d are partial schematic representations of a non-limiting exemplary embodiment of a tying machine according to the invention.

The portable electric tying machine 100 for binding plants, in particular vines, is shown in FIGS. 1a-1d at various stages of a tying operation.

The tying machine 100 comprises a body 102 and a tying head 104, immobile and disposed at a distal end of said body 102.

The tying head 104 is beak-shaped and comprises:
a housing 106 for positioning a branch to be tied, and
a guide path 108 for a tying wire 110.

The tying machine 100 further comprises a mechanism 112 for twisting said tying wire 110.

The tying machine 100 further comprises a drive system for said tying wire 110 comprising:
a first mechanism 114 for pushing the tying wire 110 to an intermediate position 116 in said tying head 104, at the end of the guide path 108, and
a second mechanism 118 movable to pull said tying wire 110 from said intermediate position 116, and bring it into a position 120, referred to as twisting position.

The first mechanism 114 comprises:
a motorized roller, called the drive roller 122, and
a second roller, called the pressing roller 124, designed to press said tying wire 110 against said drive roller 122, said motor 122 and pressing 124 rollers driving the tying wire 120 when they are in motion.

The drive roller 122 is driven by a first motor 126, located in the body 102 of the tying machine 100, which can also drive the twisting mechanism 112. Although not shown, the tying machine 100 also comprises a freewheel system enabling the first motor 126 to drive the first mechanism 114 independently of the twisting mechanism 112 and vice versa.

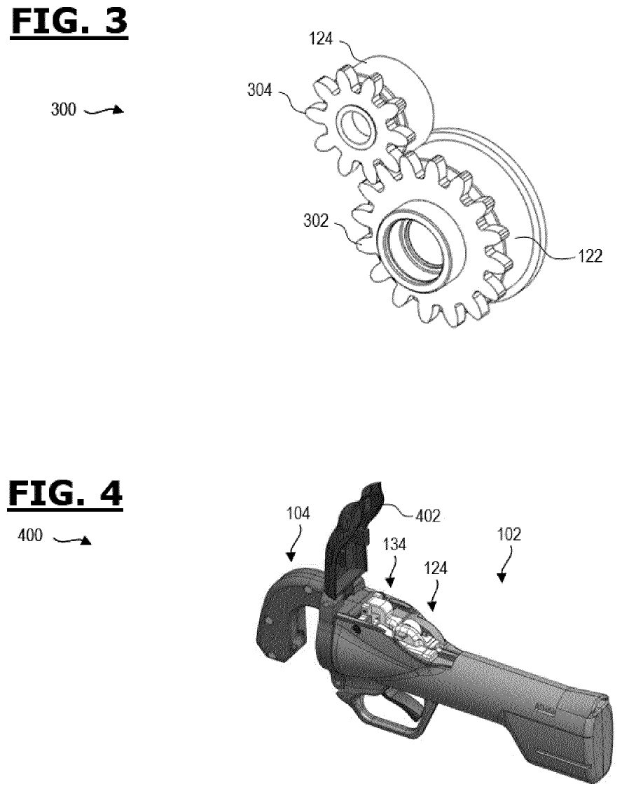

The pressing roller 124 is driven by the drive roller 122. According to the embodiment, the drive roller 122 can drive the pressing roller 124 by friction and/or by a toothed wheel system, not shown in FIGS. 1a-1d but described below in connection with FIG. 3.

The second mechanism 118 comprises a movable arm 128 equipped with a means 130 for gripping said tying wire 110. The tying machine 100 comprises a second motor 132 to drive the mechanism 118 and extend/retract the movable arm 128.

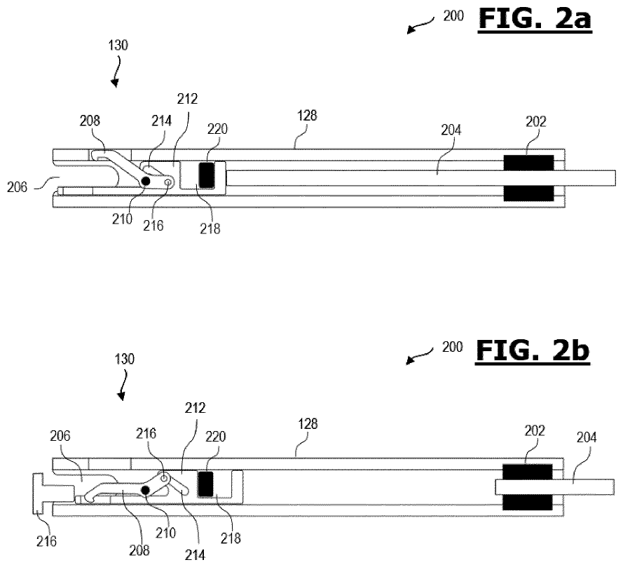

The movable arm 128 is moved, for example, by a nut-and-bolt system driven by the second motor 132, as described below in relation to FIGS. 2a and 2b.

The tying machine 100 further comprises a cutting tool 134 for cutting the tying wire 110. The cutting tool 134 is positioned in the body 102 of the tying machine 100, between the first mechanism 114 and the guide path 108 of the tying head 104. The cutting tool 126 can be triggered by the twisting mechanism 112.

The tying wire 110 enters the body 102 of tying machine 100 through an opening, not shown, located at a proximal end of said body 102. The tying wire 110 comes from a reel not shown in FIGS. 1a-1d.

FIG. 1a shows the tying machine 100 directly after it has formed a tie.

The tying wire 110 present in the tying machine 100 extends from the proximal end of the body 102 of the tying machine 100 to the cutting tool 134, going through the first mechanism 114.

To be clear, the tying wire 110 generally is similarly positioned in the tying machine after a tying wire refill.

FIG. 1b shows the tying machine 100 with the tying wire 110 positioned at intermediate position 116.

To do this, the first motor 126 has driven the first mechanism to push the tying wire 110 into the guide path 108 of the tying head 104, up to the intermediate position 116.

This drive can, for example, be performed automatically after a tie has been made, so as to preload the tying wire 110 into the tying head 104 up to the intermediate position 116 and thus prepare the tying machine for a future tie.

Similarly, this drive can, for example, be carried out automatically when the tying machine 100 is first switched on after reloading said tying wire 110.

Then, or at the same time, a branch 136 can be positioned in the housing 106.

Once the branch 136 has been positioned, the user can activate the tying machine via a trigger 138 to perform a fastening operation.

The second motor 132 drives the second mechanism 118. The movable arm 128 is translated from a retracted position as shown in FIGS. 1a and 1b, to an extended position as shown in FIG. 1c. In this way, the gripping means 130 is positioned at the intermediate position 116, enabling the gripping means 130 to grip the tying wire 110 at the intermediate position 116.

Once the tying wire 110 has been gripped, the second motor 132 drives the second mechanism 118 in the opposite direction. The movable arm 128 is moved in translation from the extended position to the retracted position. This positions the gripping means 130 at the twisting position 120, allowing the gripping means 130 to release the tying wire 110 at the twisting position 120, as shown in FIG. 1d.

The tying wire 110 is thus pulled from the intermediate position 116 to be positioned at the twisting position 120.

The tying machine's first motor 126 then drives the twisting means 112. This triggers cutting of the tying wire 110 by the cutting tool 134 and twisting of the cut tying wire on the branch 136.

Alternatively, and not shown here, a tying machine according to the invention may comprise a single motor to drive the first mechanism, the second mechanism and the twisting mechanism.

In an alternative embodiment not shown, the second motor can be replaced by any drive means capable of driving the second mechanism, such as a cylinder system.

FIGS. 2a and 2b are schematic, partial cross-sectional views of a non-limiting example of a second movable mechanism for pulling a tying wire according to the invention.

The second mechanism 200 movable to pull a tying wire is shown:
when the movable arm 128 is retracted in FIG. 2a, and
when the movable arm 128 is extended in FIG. 2b.

The movable arm 128 is hollow and comprises at a first end a nut 202 embedded in said movable arm.

The second mechanism 200 further comprises a screw 204, in engagement with the nut 202, so that when the screw 204 is rotated by a motor of the tying machine, the screw 204 causes a translational displacement of the movable arm 128.

At a second end, the movable arm 128 comprises a housing 206 designed to accommodate a tying wire.

A gripping means 130 is also included in the movable arm 128 at said second end.

The gripping means 130 is a gripping means comprising:
a lever 208 pivoting around a pin 210 integral with the movable arm 128, and
an actuating means 212, movable in the movable arm and enabling the clamp to be opened or closed by rotating the pivoting lever 208.

The actuating means 212 comprises an inclined groove 214 wherein a pin 216 integral with a first end of the pivoting lever 208 moves when the actuating means 212 moves in the movable arm 128. In this way, moving the actuating means 212 in the movable arm 128 drives the pivoting lever 208 in rotation around the groove 210 integral with the movable arm 128.

The actuating means 212 further comprises
an end, referred to as the rear end, intended to be brought into abutment with one end of the screw 204 when the movable arm 128 is retracted, this abutment moving the actuating means 212 in the opposite direction to the movement of the movable arm 128 and causing the gripping means 130 to open, as shown in FIG. 2a.
a front end intended to be brought into abutment with an element or part of the tying head, such as a nipple 216, when the movable arm 128 is extended, this abutment moving the actuating means 212 in the direction opposite the movement of the movable arm 128 and causing the gripping means 130 to close, as shown in FIG. 2b.

In this way, the gripping of a tying wire by the gripping means 130 is mechanically triggered by the actuating means 212 coming into abutment with the tying head when the gripping means 130 is positioned in the intermediate position.

In addition, the release of the tying wire by the gripping means 130 is mechanically triggered by abutment of the actuating means 212 with the screw 204 when the gripping means is positioned in said twisting position.

The actuating means 212 shown in FIGS. 2a and 2b further comprises a housing 218 for a magnetic means 220 for holding said at least one actuating means in position. The magnetic holding means 220 is a magnet, integral with the movable arm 128. The housing 218 is large enough to allow the actuator 212 to move in the movable arm as described above.

The magnet integral with the movable arm 128 temporarily prevents the actuator from moving once the gripping means has been closed and a wire has been gripped. In this way, the gripping means 130 remains closed until the actuating means 212 comes into abutment with the screw 204, and thus remains closed when the movable arm 128 retracts.

The magnet integral with the movable arm 128 furthermore temporarily prevents the actuator from moving once the gripping means has been opened and a wire has been released. In this way, the gripping means 130 remains closed until the actuating means 212 comes into abutment with the nipple 216, and thus remains open when the movable arm 128 extends.

FIG. 3 is a schematic, partial, perspective representation of a non-limiting example of a first mechanism for pushing the tying wire according to the invention.

The first mechanism 300 shown in FIG. 3 comprises a drive roller 122 and a pressing roller 124.

The first mechanism 300 further comprises:
a first toothed wheel 302 integral with said drive roller 122, and
a second toothed wheel 304 integral with the pressing roller 124, meshing with said first toothed wheel 302.

In this way, when a tying machine motor rotates the motorized roller 122, the pressing roller 124 is rotated synchronously by the first toothed wheel 302 and the second toothed wheel 304.

This reduces the likelihood of slippage of a tying wire driven by the second mechanism 300.

In addition, the first toothed wheel 302 and the second toothed wheel 304 have a tooth profile designed to accommodate a variation in the distance between a center of rotation of said drive roller 122 and a center of rotation of said pressing roller 124. Compared to a standard profile for optimized transmission of motion between two toothed wheels, the tooth profiles of the first toothed wheel 302 and the second toothed wheel 304 have:
increased tooth height,
reduced tooth thickness, and/or
increased tooth spacing.

In this way, the drive roller 122 is able to drive the pressing roller 124 synchronously even when the distance between a center of rotation of the drive roller 122 and a center of rotation of the pressing roller 124 varies, notably to accommodate the passing of a twist in the driven wire.

FIG. 4 is a schematic perspective representation of a tying machine comprising a hatch according to the invention.

The tying machine 400 shown in FIG. 4 comprises all the elements of the tying machine 100 described in relation to FIGS. 1a to 1d, although only some of these elements are visible in FIG. 4.

The tying machine 400 further comprises a hatch 402 that can be pivoted around a pivot point located on an upper part of the tying head 104. In the example shown, the hatch 402 is non-removable.

In the open position, the hatch 402 allows the user to access the first mechanism 116 and the cutting tool 134 without the need for tools and without the risk of losing the hatch 402.

In the closed position, the hatch covers the first mechanism 124 and the cutting tool 134.

Thus, when the user is in the field, they can easily access the first mechanism 116 to, for example:
perform a maintenance operation such as extricating a wire jammed in the first mechanism 116, and
position a tying wire correctly in the first mechanism 116 when a new reel of wire is used.

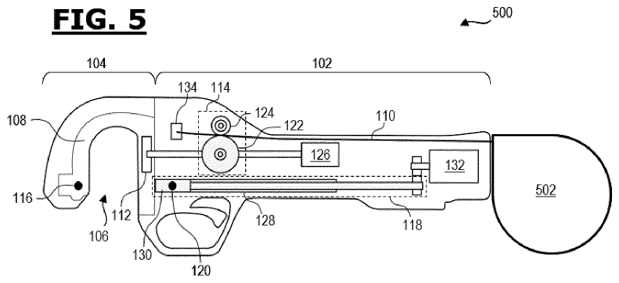

FIG. 5 is a schematic, partial, perspective representation of an example tying machine according to the invention.

The tying machine 500 shown in FIG. 4 comprises all the elements of the tying machine 100 described in relation to FIGS. 1a to 1d.

The tying machine 500 is further equipped with a removable reel 502 of tying wire, mounted on the proximal end of the tying machine 500 body 102. The reel 502 comprises a spool of tying wire, not shown.

Of course, the invention is not limited to the examples detailed above.

1. A portable electric tying machine for binding plants, in particular vines, comprising:
a body;
at least one motor in said body;
a tying head, arranged at a distal end of said body, said tying head comprising a guide path for guiding a tying wire;
a drive system for driving said tying wire in said guide path; and
a mechanism for twisting said tying wire;
wherein:
said tying head is immobile;
said drive system comprises:
a first mechanism for pushing the tying wire to a position, referred to as intermediate position, in said tying head, and
a second mechanism movable to pull said tying wire from said intermediate position, and bring it into a position, referred to as twisting position;
and wherein the second mechanism comprises a movable arm equipped with a gripping means for gripping said tying wire, said movable arm being able to be:
extended to position said gripping means at said intermediate position, so that the gripping means can grip the tying wire in the intermediate position; and
retracted to position said gripping means at said twisting position, so that the gripping means can release the tying wire in the twisting position.

2. The tying machine according to claim 1, characterized in that the tying head is beak-shaped, comprising a housing provided for positioning therein a branch of a plant, in particular a vine branch, to be tied.

3. The tying machine according to claim 1, characterized in that the first mechanism comprises:
a first motorized roller, referred to as drive roller,
a second roller, referred to as pressing roller, designed to press said tying wire against said drive roller,
so that said rollers drive the tying wire when they are in motion.

4. The tying machine according to claim 3, characterized in that the first mechanism comprises:
a first toothed wheel integral with said drive roller, and
a second toothed wheel integral with the pressing roller, meshing with said first toothed wheel.

5. The tying machine according to claim 4, characterized in that the gripping means is a clamp.

6. The tying machine according to claim 5, characterized in that the second mechanism comprises at least one actuating means to:
trigger the gripping of said tying wire by said gripping means, by abutment of said actuating means with the tying head when the movable arm is extended, and/or
trigger the release of said tying wire by said gripping means, by abutment of said actuating means, when the movable arm is retracted.

7. The tying machine according to claim 6, characterized in that the second mechanism comprises at least one position holding magnetic means for holding said at least one actuating means in position.

8. The tying machine according to claim 5, characterized in that said movable arm is translationally movable.

9. The tying machine according to claim 1, characterized in that it comprises a first motor for driving the first mechanism and the mechanism for twisting said tying wire.

10. The tying machine according to claim 9, characterized in that it comprises:
a first freewheel system enabling said first mechanism to be driven by said first motor only in a first direction of rotation of a drive shaft of said first motor, and
a second freewheel system enabling said twisting mechanism to be driven by said first motor only in a second direction of rotation of said motor shaft, opposite to said first direction of rotation.

11. The tying machine according to claim claim 9, characterized in that it comprises a second motor, different from the first motor, for driving the second mechanism.

12. The tying machine according to claim 1, characterized in that it comprises a cutting tool for cutting the tying wire, wherein the cutting tool can be triggered by the twisting mechanism.

13. The tying machine according to claim 1, characterized in that the body comprises at least one hatch allowing access to at least the first mechanism.

14. The tying machine according to claim 1, characterized in that it is equipped with a reel of tying wire.
